(19) United States
(12) Patent Application Publication
(10) Pub. No.: US 2009/0118650 A1
(43) Pub. Date: May 7, 2009

(54) HYDRAULIC DRIVEN MASSAGING BAR

(76) Inventor: Wen-Chieh FANG, Taipei City (TW)

Correspondence Address: LEONG C LEI, PMB # 1008, 1867 YGNACIO VALLEY ROAD, WALNUT CREEK, CA, 94598, US

(21) Appl. No.: 11/933,430

(22) Filed: Nov. 1, 2007

(51) Int. Cl. A61H 1/00; A61H 7/00

(52) U.S. Cl. 601/46; 601/134

(57) ABSTRACT

A hydraulic driven massaging bar is disclosed to include a hollow bar-like body defining therein a water input passage and a water output passage, an elastic head member, an elastic connection member connected between the elastic head member and one end of the hollow bar-like body, a waterwheel pivotally mounted in the hollow bar-like body and rotatable by water running through the water input passage toward the water output passage, a reciprocating rod affixed to the elastic head member and suspending in the elastic connection member, and a rotating wheel coupled between the waterwheel and the reciprocating rod for moving the reciprocating rod and the elastic head member back and forth upon rotation of the rotating wheel with the waterwheel.

### BACKGROUND OF THE INVENTION

(a) Technical Field of the Invention

The present invention relates to a massaging apparatus and more particularly, to a hydraulic driven massaging bar.

(b) Description of the Prior Art

Various penis-shaped massaging bars for females are commercially available. These penis-shaped massaging bars include two types, i.e., the manual operated type and the electrical type. When using a manual operated penis-shaped massaging bar, the massaging bar is inserted into the vagina and moved back and forth in the vagina with the hand. An electrical type penis-shaped massaging bar for female is a sex toy vibrator, which uses a battery or AC power supply to drive a motor, causing a part of the massaging bar to make a rotating, oscillating, or reciprocating motion. An electrical type penis-shaped massaging bar for female cannot be used during bathing. Using an electrical type penis-shaped massaging bar in a bathroom may cause a short circuit or electric shock.

### SUMMARY OF THE INVENTION

The primary purpose of the present invention is to provide a hydraulic driven massaging bar, which produces a vibrating motion and a reciprocating motion. It is another object of the present invention to provide a hydraulic driven massaging bar, which produces a vibrating massaging effect and a reciprocating massaging effect without consumption of electricity. It is still another object of the present invention to provide a hydraulic driven massaging bar, which is practical for use in a wet environment.

To achieve these and other objects of the present invention, the hydraulic driven massaging bar comprises a hollow bar-like body defining therein a water input passage and a water output passage, an elastic head member, an elastic connection member connected between the elastic head member and one end of the hollow bar-like body, a waterwheel pivotally mounted in the hollow bar-like body and rotatable by water running through the water input passage toward the water output passage, a reciprocating rod affixed to the elastic head member and suspending in the elastic connection member, and a rotating wheel coupled between the waterwheel and the reciprocating rod for moving the reciprocating rod and the elastic head member back and forth upon rotation of the rotating wheel with the waterwheel.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic sectional plain view of a hydraulic driven massaging bar in accordance with the present invention.

FIG. 2 is a schematic sectional view of the present invention, showing the forward stroke of the reciprocating rod and the head member.

FIG. 3 is a schematic sectional view of a part of the present invention, showing eccentric positioning of the waterwheel in the water input passage.

FIG. 4 is a schematic sectional view of a part of the present invention, showing a reciprocating action of the reciprocating rod.

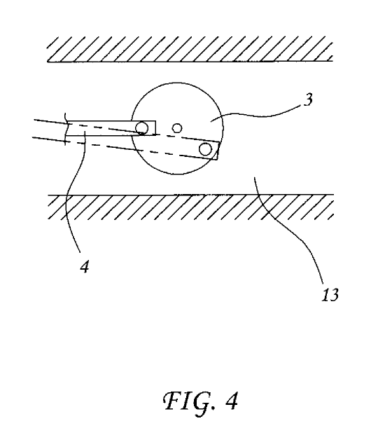

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

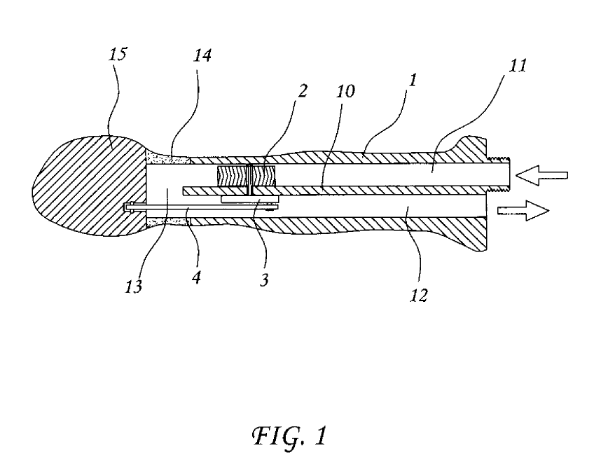

Referring to FIG. 1, a hydraulic massaging in accordance with the present invention is shown comprised of a body 1.

The body 1 is a hollow bar-like member shaped like a penis, having two opposite ends, namely, the front end and the rear end. The front end of the body 1 has its front end fixedly connected with an elastic connection member 14 and a head member 15. The elastic connection member 14 is connected between the periphery of the head member 15 and the periphery of the front end of the body 1, and able to return to its former shape and size after being pulled. The head member 15 is shaped like the glans. The elastic connection member 14 and the head member 15 are made of an elastic member, preferably, silicon rubber.

Referring to FIG. 1 again, a partition member 10 is mounted in the body 1 in longitudinal direction to divide the inside space of the partition member 10 into a water input passage 11 and a water output passage 12. Further, a gate 13 is defined in the first end of the body 1 within the elastic connection member 14 and the rear side of the head member 15 in communication between one end of the water input passage 11 and one end of the water output passage 12. The other end of the water input passage 11 is connected to a shower pipe (not shown).

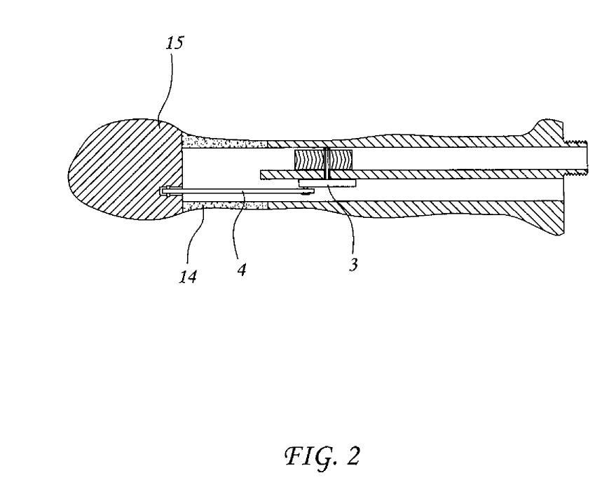

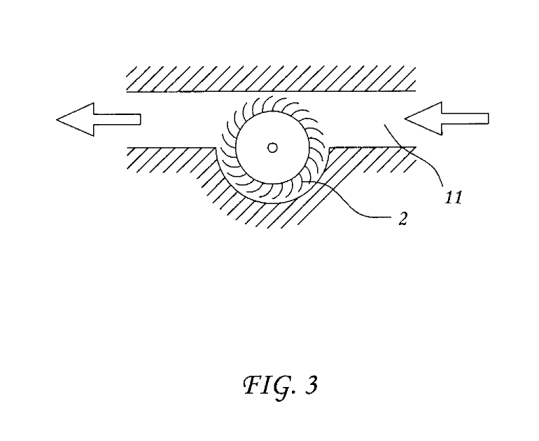

Referring to FIGS. 2˜4 and FIG. 1 again, a waterwheel 2 is pivotally mounted in the water input passage 11 inside of the body 1 in an eccentric manner relative to the water input passage 11 (see FIG. 3) and rotatably by water passing through the water input passage 11 and the gate 13 toward the water output passage 12. A reciprocating rod 4 is longitudinally suspending in the water output passage 12, having its one end fixedly connected to the head member 15 and its other end coupled to the waterwheel 2 through a transmission device, for example, a rotating wheel 3. The rotating wheel 3 is rotatable with the waterwheel 2 to reciprocate the reciprocating rod 4. According to this embodiment, the rotating wheel has its wheel shaft fixedly and coaxially connected to the wheel shaft of the waterwheel 2, and the reciprocating rod 4 has its rear end eccentrically coupled to the rotating wheel 3 through a slip joint. Therefore, when the rotating wheel 3 is rotating, the reciprocating rod 4 is forced to move back and forth.

Referring to FIGS. 1˜4 again, when running water is guided into the water input passage 11, it runs in proper order through the water input passage 11, the gate 13 and the water output passage 12. When running water is running through the water input passage 11, it forces the waterwheel 2 to rotate and to vibrate (because the waterwheel 2 is pivotally mounted on the partition member 11 in an eccentric manner relative to the water input passage 11), and at the same time the rotating wheel 3 is rotatable with the waterwheel 2 to reciprocate the reciprocating rod 4 and to further move the head member 15 back and forth. When the reciprocating rod 4 is moved forwards, the elastic connection member 14 is stretched, and the head member 15 is forced forwards by the reciprocating rod 4. On the contrary, when the reciprocating rod 4 is moved backwards, the elastic connection member 14 is released from the stretching force, and therefore the head member 15 is pulled backwards by the elastic connection member 14.

Thus, the user can aim the head member 15 at the body to massage a particular part of the body during reciprocating motion of the reciprocating rod 4, stimulating its blood circulation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hydraulic driven massaging bar comprising:
a hollow bar-like body, said hollow bar-like body comprising a front end, a rear end, an elastic head member, an elastic connection member connected between said elastic head member and the front end of said hollow bar-like body, a water input passage for guiding water into said hollow bar-like body, a water output passage for guiding water out of said water input passage, a partition member separating said water input passage and said water output passage, and a gate in communication between one end of said water input passage and one end of said water output passage within said elastic connection member for allowing water to flow from said water input passage to said water output passage;
a waterwheel eccentrically and pivotally mounted in said water input passage and rotatable and vibratable by water running through said water input passage;
a rotating wheel coupled to said waterwheel and disposed inside said water output passage for synchronous rotation with said waterwheel; and
a reciprocating rod disposed in said water output passage and adapted to move said head member back and forth upon rotation of said rotating wheel with said waterwheel, said reciprocating rod having a front end fixedly connected to said head member and a rear end pivotally and eccentrically coupled to said rotating wheel.

2. The hydraulic driven massaging bar as claimed in claim 1, wherein said waterwheel is pivotally mounted on said partition wall.

3. The hydraulic driven massaging bar as claimed in claim 1, wherein rotating wheel is pivotally mounted on said partition wall and coupled to said waterwheel for synchronous rotation with said waterwheel.
